(19) United States
(12) Patent Application Publication
(10) Pub. No.: US 2009/0114777 A1
(43) Pub. Date: May 7, 2009

(54) CLAMPING DEVICE FOR SECURING DATA CABLES

(75) Inventor: YI-CHIEH YEH, Tu-Cheng (TW)

Correspondence Address: PCE INDUSTRY, INC.;ATT. Steven Reiss, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 11/964,875

(22) Filed: Dec. 27, 2007

(30) Foreign Application Priority Data
Nov. 5, 2007 (CN) 200710202388.3

(51) Int. Cl. F16L 3/02

(52) U.S. Cl. 248/74.3

(57) ABSTRACT

A clamping device (100) for clamping a data cable (60) with a plug includes: a clamping unit (10), a limitation cabinet (20) and a plurality of elastic elements (40). The clamping unit defines a receiving groove (115) configured for receiving the plug of the data cable. The limitation cabinet defines a cavity. The clamping unit is disposed in the cavity, and is spaced apart from the limitation cabinet. The elastic elements are disposed between the clamping unit and the limitation cabinet.

### TECHNICAL FIELD

The present invention relates generally to a clamping device, and more particularly, to a clamping device for securing data cables.

### BACKGROUND

During manufacturing, electronic products, such as mobile phone, generally need to be tested for quality control. During testing, the mobile phone may be connected to the test equipment with a cable. In one testing process, the data cable is manually connected to the mobile phone. However, this manual operation is subjected to human errors and non-uniform force may be applied to the cable interface. In an alternative testing process, whereby the cable is mechanically connected, the mobile phone is inserted in a slot of a fixed structure, with the testing connector exposed. The testing cable, previously aligned with the slot of the fixed structure is plugged into the testing connector the mobile phone. Although the data cable will be connected to the mobile phone for most of the time, the tolerance (space) between the mobile phone and the sides of the slot, of the fixing structure, may allow misalignment of the data cable and the mobile phone. Therefore, the test efficiency is greatly reduced.

Therefore, a new clamping device for securing data cables is desired in order to overcome the above-described shortcomings.

### SUMMARY

One embodiment of a clamping device for clamping a data cable with a plug includes a clamping unit, a limitation cabinet and a plurality of elastic elements. The clamping unit defines a receiving groove configured for receiving the plug of the data cable. The limitation cabinet defines a cavity. The clamping unit is disposed in the cavity, and is spaced from the limitation cabinet. The elastic elements are disposed between the clamping unit and the limitation cabinet.

Other advantages and novel features will become more apparent from the following detailed description when taken in conjunction with the accompanying drawings.

### BRIEF DESCRIPTION OF THE DRAWINGS

Many aspects of the present clamping device can be better understood with reference to the following drawings. The components in the drawings are not necessarily drawn to scale, the emphasis instead being placed upon clearly illustrating the principles of the clamping device. Moreover, in the drawings, like reference numerals designate corresponding parts throughout the several views.

FIG. 1 is an exploded view of a clamping device.

FIG. 2 is similar to FIG. 1, but from another aspect.

FIG. 3 is an assembled schematic view of the clamping device.

FIG. 4 is a schematic view of the clamping device with a data cable.

FIG. 5 is a schematic view of FIG. 4 when the data cable is inserted into the clamping device.

### DETAILED DESCRIPTION OF THE PREFERRED EMBODIMENTS

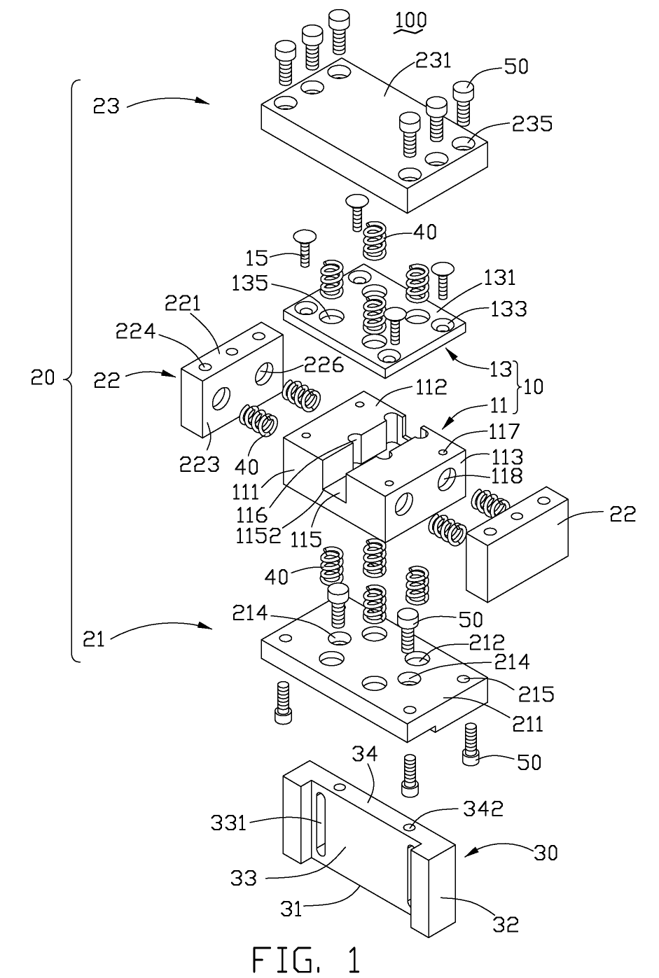

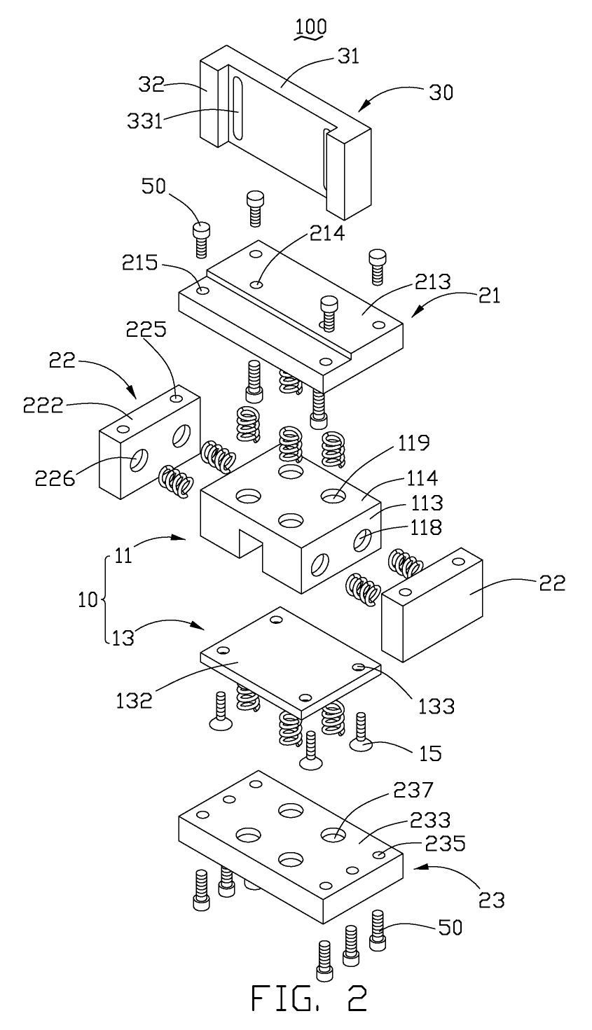

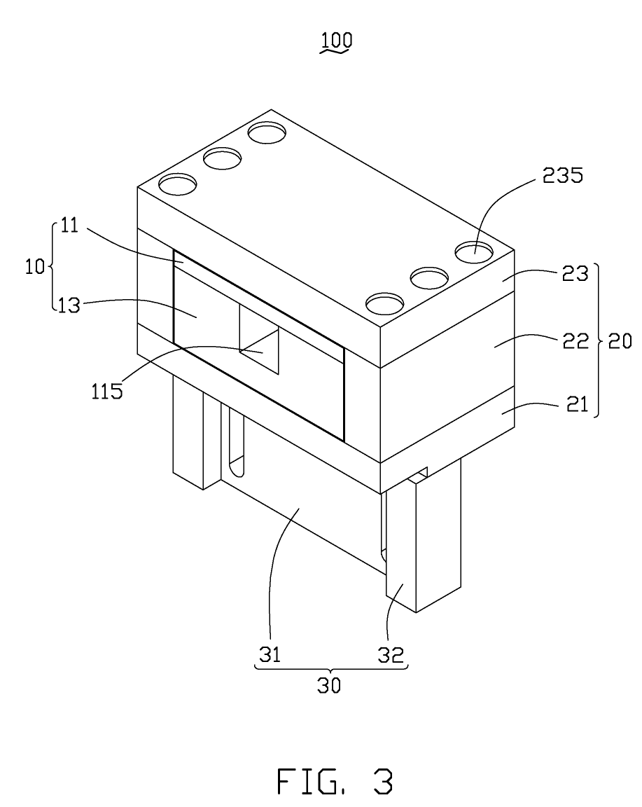

Referring to FIGS. 1 to 3, a clamping device 100 (i.e. jig), includes a clamping unit 10, a limitation cabinet 20, a base seat 30, a plurality of elastic elements 40 and a plurality of screws 50.

The clamping unit 10 includes a support element 11, a cover 13 and four bolts 15. The support element 11 is substantially cuboid, and includes a top surface 112, a bottom surface 114, two sidewalls 111 and two end walls 113. The top surface 112 of the support element 11 defines a receiving groove 115. The receiving groove 115 communicates with the two sidewalls 111, and the receiving groove 115 is configured for receiving a plug of a data cable. The receiving groove 115 is cooperatively defined by two parallel inside walls and a bottom surface. Each inside wall is perpendicular to the bottom surface so as to form a right angle 1152. Each inside wall defines two spaced apart half cylindrical grooves 116, which is in communication with the receiving groove 115. The half cylindrical grooves 116 are used for containing a machine apparatus so as to precisely form the right angles 1152. The right angles 1152 of the receiving groove 115 may fittingly engage with the plug of the data cable. The top surface 112 of the support element 111 respectively defines a screw hole 117 at four corners thereof. The end walls 113 respectively define two containing grooves 118. The bottom surface 114 defines four retaining grooves 119. A diameter of each containing groove 118 is the same as that of each retaining groove 119.

The cover 13 includes an upper surface 131 and a lower surface 132. The length and width of the cover 13 is similar to that of the support element 11. The upper surface 131 respectively defines a stepped hole 133 at four corners thereof. Each stepped hole 133 is corresponded to a given screw hole 117 of the support element 11. The upper surface 131 defines four apertures 135 among the stepped holes 133. The cover 13 is fixed to the support element 10 by the bolts 15 so as to constitute the clamping unit 10.

The limitation cabinet 20 is substantially cuboid, and includes a bottom board 21, a top board 23 and two side boards 22.

The bottom board 21 includes a first surface 211 and a second surface 213. The first surface 211 defines four resisting grooves 212 and two stepped screw holes 214. The stepped screw holes 214 are between the four resisting grooves 21. Each resisting groove 212 is corresponding to a given retaining groove 119. The first surface 211 respectively defines a screw hole 215 at four corners thereof.

Each side board 22 includes a top surface 221, a bottom surface 222 and a connecting surface 223 therebetween. The top surface 221 defines three screw holes 224. The bottom surface 222 defines two screw holes 225 corresponding to the screw holes 215 of the bottom board 21. The connecting surface 223 defines two slots 226 corresponding to the two containing grooves 118 of the support element 11. A distance between the two side boards 22 is larger than a width of the support element 11.

The top board 23 includes an upper surface 213 and a lower surface 233. The upper surface 231 respectively defines three stepped holes 235 at two ends thereof corresponding to the three screw holes 224 of the side board 22. The lower surface 233 defines four fixing groove 237 corresponding to the apertures 135 of the cover 13. A distance between the top board 23 and the bottom board 21 is larger than a height of the clamping unit 10.

The base seat 30 includes a holding portion 31 and two bending portions 32 perpendicularly extending therefrom. The holding portion 31 includes two side surfaces 33 and a top surface 34. The holding portion 31 defines two through holes 331 at two ends thereof adjacent to a corresponding bending portion 32. Each through hole 331 is substantially elliptical. The bending portions 32 with the through holes 331 are configured for connecting to a dynamic mechanism such as a cylinder so as to make the clamping device move.

The elastic elements 40, in an illustrated embodiment, are helical springs. A diameter of each spring 40 is similar to that of the slots 226, the retaining grooves 119 and the fixing grooves 237 so as to be received therein.

In assembly, the bottom board 21 is placed on the base seat 30, and the stepped screw holes 214 of the bottom board 21 are aligned with the screw holes 342 of the base seat 30. Then, two of the screws 50 are inserted into the stepped holes 214 and the screw holes 342 so as to fix the bottom board 21 with base seat 30. After that, the side boards 22 are positioned at two ends of the bottom board 21 to make the slots 226 of each side board 22 opposite to each other. The screw holes 225 of the side boards 22 are aligned with the screw holes 215 of the bottom board 21. Four of the screws 50 are inserted into the screw holes 225, 215 so as to fix the side boards 22 to the bottom board 21. Next, four of the springs 40 are respectively inserted into a corresponding resisting groove 212. Another four of the springs 40 are respectively inserted into a corresponding slot 226. The cover 13 is placed on the support element 11, and the stepped holes 133 of the cover 13 are aligned with the screw holes 117 of the support element 11. The bolts 15 are inserted into the stepped holes 133 and the screw holes 117 so as to be assembled into the clamping unit 10.

After the clamping unit 10 is assembled, the clamping unit 10 is put into the bottom board 21, and is between the side boards 22. At the same time, the springs 40 in the slots 226 are partially received in the containing grooves 118. The springs 40 in the resisting grooves 212 are partially received in the retaining grooves 119. Then, another four of the springs 40 are inserted into the apertures 135. The top board 23 is placed above the cover 13, and the two ends of the top board 23 are placed on the side boards 22. Accordingly, the springs 40 in the apertures 135 are received in the fixing grooves 217. Finally, the screws 50 are inserted into the stepped screw hole 235 and the screw holes 224 so as to fix the top board 23 to the side boards 22. Therefore, the assembled process is completed.

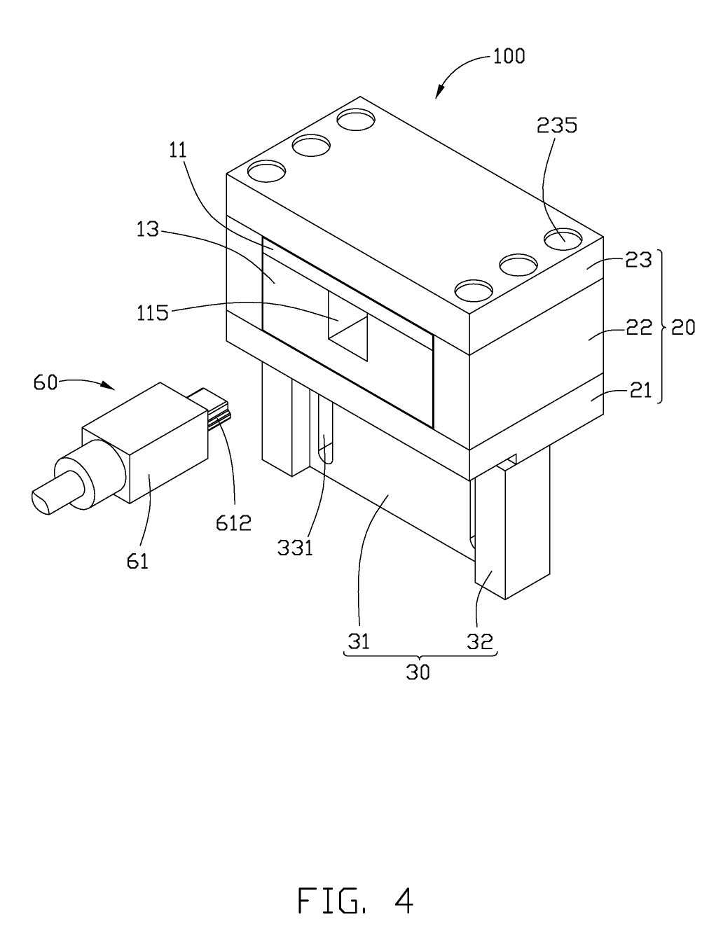

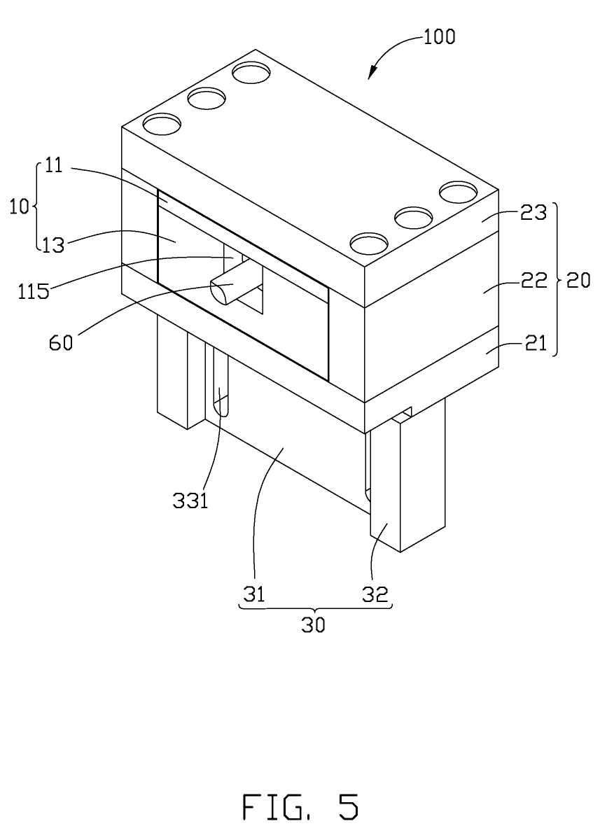

Referring to FIGS. 4 and 5, a data cable 60 is provided. The data cable 60 includes a plug head 61 and an electrical terminal 612. When the clamping device 100 is used, the plug head 61 of the data cable 60 is inserted into from one side of the receiving groove 115. The electrical terminal 612 of the data cable 60 is exposed from the other side of the receiving groove 115. The bended portions 32 of the base seat 30 are connected to a dynamic mechanism so that the dynamic mechanism may bring the clamping device 100 and the data cable 60 to move together.

Since the distance between the side boards 22 is larger than the distance between the end surfaces 113 of the support element 11, the distance between the top board 23 and the bottom board 21 is larger than a height of the clamping unit 10, the clamping device 10 may move at a predetermined range. Accordingly, the clamping unit 10 may have two directional offsets relative to the limitation cabinet 20. When the assemble between the mobile phone and the slot of the fixed structure exists a dimensional tolerance, the clamping unit 10 may be adjusted relative to the limitation cabinet 20 so as to more accurately be inserted into the mobile phone. In addition, the clamping device 100 is carried by the dynamic mechanism to move, the plug force may be more uniform, and the work efficiency is greatly improved.

In alternative embodiments, the base seat 30 may be integrally formed with the bottom board 21. Understandably, the number of the elastic elements 40 between the clamping unit 10 and the limitation cabinet 20 may be one or more.

As described above, the preferred embodiment provides a clamping device for a data cable, which may efficiently adjust tolerance. It is, however, to be understood that the clamping device could potentially be useful in other applications in which it may be desirable to allow clamping something to be inserted into an interface of other electronic devices so as to attain a stable assembly.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A clamping device for clamping a data cable with a plug, the clamping device comprising:
a clamping unit defining a receiving groove configured for receiving the plug of the data cable;
a limitation cabinet, the limitation cabinet defining a cavity, the clamping unit disposed in the cavity, and spaced apart from the limitation cabinet; and
a plurality of elastic elements, the elastic elements disposed between the clamping unit and the limitation cabinet.

2. The clamping device as claimed in claim 1, wherein the clamping unit includes a support element and a cover, the cover is positioned on the support element, and the receiving groove is defined in the support element.

3. The clamping device as claimed in claim 3, wherein the cover is fixed to the support element with screws.

4. The clamping device as claimed in claim 1, wherein the limitation cabinet includes a bottom board, a top board and two side boards, the two side boards are disposed at two ends of the bottom board, and the top board is disposed on the two side boards, the bottom board, the top board and the two side boards cooperatively define the cavity.

5. The clamping device as claimed in claim 4, wherein the side board and the support element respectively defines at least one slot, the elastic elements are received in the at least one slot.

6. The clamping device as claimed in claim 1, further comprising a base seat, wherein the base seat is connected to the bottom board, and the base seat defines two through holes configured for connecting to a dynamic mechanism.

7. The clamping device as claimed in claim 6, wherein the base seat includes a holding portion and two bended portions, and the bended portions are perpendicularly extended from the holding portion at two ends thereof.

8. An apparatus for assembling or removing a data cable with a plug to or from a portable electronic device, the apparatus comprising:
a clamping unit defining a receiving groove configured for receiving the plug of the data cable;
a limitation cabinet, the limitation cabinet defining a cavity, the clamping unit disposed in the cavity, and spaced apart from the limitation cabinet; and
a plurality of elastic elements, the elastic elements disposed between the clamping unit and the limitation cabinet.

9. The apparatus as claimed in claim 8, wherein the limitation cabinet includes a bottom board, a top board and two side boards, the two side boards are disposed at two ends of the bottom board, and the top board is disposed on the two side boards, the bottom board, the top board and the two side boards cooperatively define the cavity.

10. The apparatus as claimed in claim 9, wherein the side board and the support element respectively defines at least one slot, the elastic elements are received in the at least one slot.
